(19) United States
(12) Patent Application Publication
(10) Pub. No.: US 2015/0233504 A1
(43) Pub. Date: Aug. 20, 2015

(54) TUBULAR STAND RACKING SYSTEM

(71) Applicant: Frank's International, LLC, Houston, TX (US)

(72) Inventors: Logan E. Smith, Youngsville, LA (US); Jeremy R. Angelle, Youngsville, LA (US)

(73) Assignee: Frank's International, LLC, Houston, TX (US)

(21) Appl. No.: 14/184,896

(22) Filed: Feb. 20, 2014

(51) Int. Cl. F16L 21/00; F16L 15/08; F16L 21/08

(52) U.S. Cl. CPC F16L 21/002; F16L 21/08; F16L 15/08

(57) ABSTRACT

An extension assembly, apparatus, and method for racking a tubular are provided. The method includes attaching a coupler to the tubular, such that the coupler receives an end of the tubular. The coupler includes a material that is softer than a material of the end of the tubular, so as to protect a threaded area of the tubular. The method also includes attaching an extension to the coupler such that a height of the tubular plus a height of the extension meets a minimum height of a rack, and positioning the tubular in the rack.

### BACKGROUND

In oilfield operations, tubulars such as drill pipe and casing are run into a wellbore. The tubulars are generally run into the wellbore as “stands.” Each stand includes several, for example, three, lengths or “joints” of pipe made up together, end-on-end. Running in multiple joints at once as part of the stand reduces the amount of time taken to connect the joints together, since there are fewer joints that must be made up during run in or disassembled during removal of the tubular from the wellbore.

Prior to run-in, or after the stands are removed from the wellbore, the stands may be stored vertically in a pipe rack. The process of storing the stands in the pipe rack may be known as “racking back” the stand. Each stand can be run into the wellbore, removed therefrom (“tripped out”), and racked back multiple times, so long as the stands are not excessively damaged during use.

The pipe rack is configured to accept a range of stand lengths. For example, a stand may be expected to have a length of about 130 feet. Thus, the rack may be configured to accept stands of that length, plus or minus a tolerance of, for example, five feet. However, the lengths of the joints may vary. Accordingly, during assembly of the stands, operators generally must take care to ensure that joints are selected such that the overall length of the stand falls within the range acceptable for storage in the pipe rack.

In some cases, joints that are too short for three to be put together to form a stand of acceptable length may remain. In such cases, the stands made from these joints are generally required to be formed as “doubles” or even “singles” (i.e., stands of two joints or one joint, respectively), which generally are not racked back like “triples” (i.e., three joint stands). This results in extra connections between stands that must be made up and separated every time the stands are run in or tripped out. The result is wasted rig time, space, and, accordingly, expense.

### SUMMARY

Embodiments of the disclosure may provide an apparatus for extending a tubular. The apparatus includes a coupler including a top and a bottom. The coupler is configured to receive an end of the tubular and attach to the tubular, and is at least partially constructed from a material that is softer than the tubular, such that the coupler is configured to protect a threaded area of the tubular when the tubular is received into the coupler. The apparatus also includes a bushing received at least partially through the coupler, which extends from the bottom of the coupler, away from the top. The apparatus also includes an extension receiving the bushing, such that, when the tubular is received into the coupler and the bushing is received into the extension, the extension extends substantially concentric to the tubular.

Embodiments of the disclosure may also provide a method of racking a tubular. The method may include attaching a coupler to the tubular, such that the coupler receives an end of the tubular. The coupler includes a material that is softer than a material of the end of the tubular, so as to protect a threaded area of the tubular. The method also includes attaching an extension to the coupler such that a height of the tubular plus a height of the extension meets a minimum height of a rack, and positioning the tubular in the rack.

Embodiments of the disclosure may also provide an extension assembly. The extension assembly includes a coupler configured to be positioned around a threaded area of a tubular, proximal to an end of the tubular. The extension assembly also includes an extension having an open end configured to receive at least a portion of the coupler, the extension being configured to be disposed at least partially between the end of the tubular and a support surface. The extension assembly further includes an insert that includes a bottom plate disposed within the extension. The coupler is configured to bear on the bottom plate. The bottom plate transfers a weight of the tubular from the coupler to the extension.

It is to be understood that both the foregoing general description and the following detailed description are exemplary and explanatory only and are not restrictive of the present teachings, as claimed.

### BRIEF DESCRIPTION OF THE DRAWINGS

The accompanying drawing, which is incorporated in and constitutes a part of this specification, illustrates an embodiment of the present teachings and together with the description, serves to explain the principles of the present teachings. In the figures:

FIG. 1 illustrates a simplified schematic view of a pipe rack with two stands, according to an embodiment.

FIG. 2 illustrates an enlarged perspective view of a portion of the stand and the extension assembly, according to an embodiment.

FIG. 3 illustrates an exploded view of the tubular and the extension assembly, according to an embodiment.

FIG. 4 illustrates a cross-sectional view of the extension assembly, according to an embodiment.

FIG. 5 illustrates a perspective view of a latch and band of a coupler of the extension assembly, according to an embodiment.

FIG. 6 illustrates a perspective view of a portion of the stand and another embodiment of the extension assembly.

FIG. 7 illustrates a side, cross-sectional view of the stand and the extension assembly of FIG. 6, according to an embodiment.

FIG. 8 illustrates a flowchart of a method for extending a stand, according to an embodiment.

It should be noted that some details of the figure have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawing that forms a part thereof, and in which is shown by way of illustration a specific exemplary embodiment in which the present teachings may be practiced. The following description is, therefore, merely exemplary.

The numerical ranges and parameters setting forth the broad scope of the disclosure are approximations. Any numerical value, however, inherently contains certain errors necessarily resulting from the standard deviation found in their respective testing measurements. Moreover, all ranges disclosed herein are to be understood to encompass any and all sub-ranges subsumed therein.

Further, as the term is used herein, “attach” (and grammatical equivalents thereof) is defined broadly to include any type of physical connectivity between two structures. This includes coupling two parts directly together via threading, welding, fastening, brazing, etc., or coupling two parts together via one or more intermediary structures disposed between the two parts that are “attached.” Moreover, two structures may be “attached” while allowing for relative movement therebetween. Further, the terms “bottom” and “top” are used herein to refer to the relative positioning of elements in the figures, but are not meant to limit the disclosed embodiments to a particular orientation in space, unless otherwise expressly stated herein.

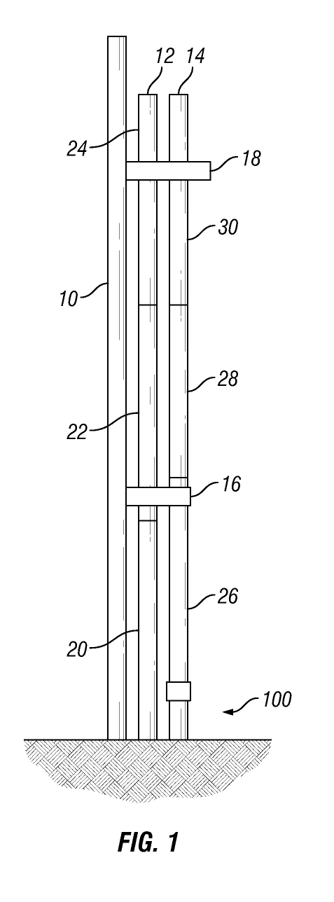

FIG. 1 illustrates a simplified schematic view of a rack 10 and two stands 12, 14, according to an embodiment. It should be readily appreciated that the view of FIG. 1 is greatly simplified for illustrative purposes. Accordingly, although not shown, the rack 10 may be integrated into a drilling rig, including any pipe handling equipment (hoists, elevators, spiders, top drive, etc.), derricks, platforms, boards, etc., without limitation.

As shown, the rack 10 generally includes support members 16, 18 that may receive and secure the stands 12 and 14 in place. In at least one specific embodiment, the stands 12, 14 may each be made of three joints 20, 22, 24, and 26, 28, and 30, respectively, which may have a nominal or expected length. In other embodiments, the stands 12, 14 may each be made up of 1, 2, or 4 or more joints. In turn, the stands 12, 14 may have an expected or nominal length equal to sum of the lengths of the joints 20-24 and 36-30, respectively. In a vertical orientation of the stands 12, 14, this may also be referred to as the height of the stand 12, 14. In one specific embodiment, the nominal expected height of the stands 12, 14 may be about 130 feet.

The rack 10 may be configured to receive and secure stands 12, 14 with the expected or nominal length (height), plus or minus a tolerance. In one specific embodiment, the tolerance may be about 5 feet. Such configuring of the rack 10 may take a variety of forms. For example, equipment that may employ the rack 10 may be configured to engage the stands 12, 14 at a certain location, proximal the top of the stands 12, 14. Additionally or alternatively, the support members 16, 18, or any other structures of the rack 10, may be engage and secure the stands 12, 14 toward the top thereof, such that, if the length (or height, in a vertical orientation) of the stands 12, 14 is too small, the support member 18 may, for example, not securely engage the top of the stands 12, 14.

One or more of the joints 26-30 of the stand 14 may be shorter than the expected length, which may result in the stand 14 having a height that is less than the minimum height (i.e., nominal minus tolerance) that the rack 10 is configured to receive. Accordingly, the stand 14 may be coupled with an extension assembly 100, as will be described in greater detail below. The extension assembly 100 may fit over a pin (i.e., externally threaded) end of the bottom joint 26 of the stand 14. When racked, the weight of the stand 14 may be transmitted to the ground (or platform, etc.) through the extension assembly 100, thereby securing the extension assembly 100 to the stand 14. The height of the extension assembly 100 may make up for the shortfall of the height in the stand 14, such that the stand 14 meets or exceeds the minimum height that the rack 10 is configured to handle.

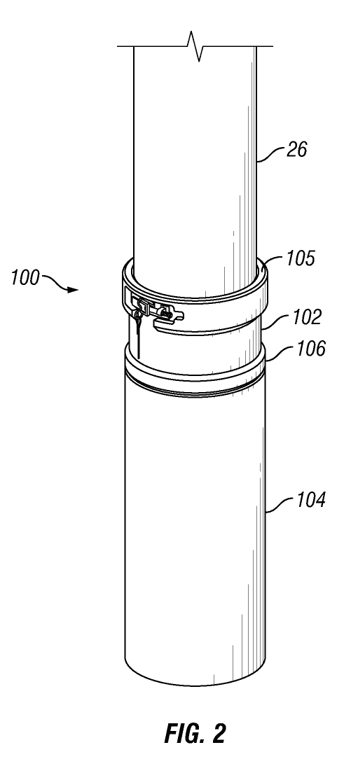

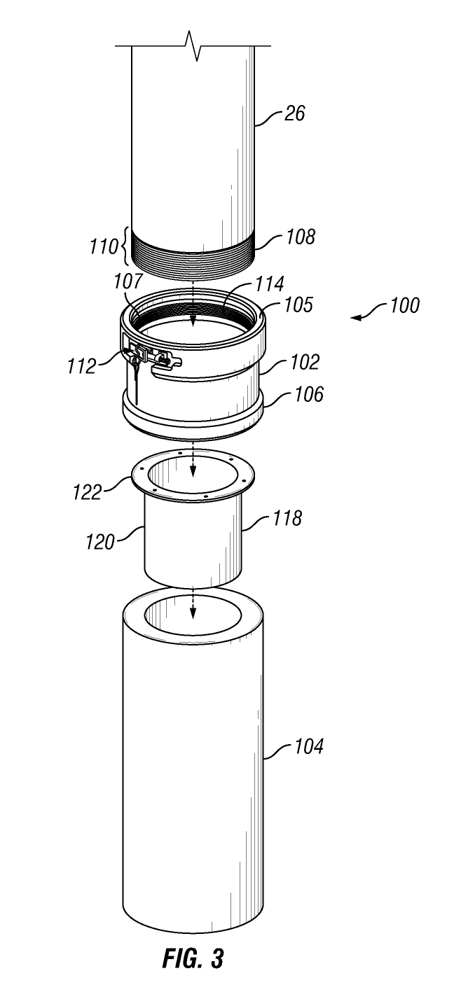

FIG. 2 illustrates a perspective view of the extension assembly 100 and a portion of the joint 26 making up part of the stand 14, according to an embodiment. FIG. 3 illustrates an exploded view of the extension assembly 100 and the joint 26, according to an embodiment. It will be appreciated that the joint 26 may be replaced with any suitable tubular, which, for example, may be extended for any reason. Referring now to FIGS. 2 and 3, the extension assembly 100 may generally include a coupler 102 and an extension 104, which, when assembled may be substantially concentric (i.e., concentric within a reasonable tolerance) with the joint 26. The coupler 102 may define a top 105 and a bottom 106, with an inside diameter 107 extending therebetween that has a dimension that is greater than an outside diameter of the joint 26, at least proximal to a pin end 108 thereof.

The pin end 108 may define a threaded area 110. The pin end 108 of the joint 26 may be received into the coupler 102 through the top 105, such that the threaded area 110 is disposed radially inside of the coupler 102, as can be appreciated from FIG. 2. Thus, the coupler 102 may function as a thread protector. In such case, the coupler 102 may be at least partially formed from a material that is softer than the material making up the joint 26. For example, the coupler 102 may be formed at least partially from an elastomeric or polymeric material, but any other material that is relatively soft in comparison to the joint 26 may be employed. Thus, the coupler 102 may serve to protect the threaded area 110 of the joint 26 from abrasion, deformation, or any other type of damage while the joint 26 is being handled outside of the wellbore.

In some embodiments, the coupler 102 may include a latch 112 and a band 114. The band 114 may be a split ring, coupled on each circumferential end to the latch 112. The band 114 may be retained in a groove defined in the inner diameter 107 of the coupler 102, as will be described in greater detail below. Closing the latch 112 may result in the circumference of the band 114 being reduced, causing the band 114 to engage the joint 26, for example, above the threaded area 110. The band 114 may have a set of teeth or another type of structure that increases friction or bites into the joint 26, and may rely on such engagement to maintain the connection with the joint 26 and avoid slippage therewith. In other embodiments, knurls, rough finishes, etc. may be provided so as to assist in the gripping of the joint 26 via the band 114.

The latch 112 and the band 114 together may provide for rapid attachment of the coupler 102 to the joint 26, without threading, and thus without regard for the type or size of threads of the threaded area 110. However, in other embodiments, the coupler 102 may employ a threaded connection or may otherwise be attached to the joint 26, so as to protect the threaded area 110, for example. Further, in at least one embodiment, the coupler 102, including the latch 112 and band 114 may be similar or the same as one or more of the apparatuses discussed in U.S. Pat. No. 7,357,434, which is incorporated herein by reference in its entirety, to the extent not inconsistent with the present disclosure.

The extension assembly 100 may also include a bushing 118. The bushing 118 may include a base 120 and a flange 122. The flange 122 may have an outer diameter that is larger than the outer diameter of the base 120. The bushing 118 may be hollow, as shown, or solid. In hollow embodiments, the bushing 118 may be sized such that it does not fit over the pin end 108 of the joint 26. Further, the outer diameter of the flange 122 may be sized such that it may be larger than an opening (not visible in FIG. 2 or 3) in the bottom 106 of the coupler 102, which prevents the flange 122 from proceeding through the coupler 102, as will be described in greater detail below. Accordingly, the bushing 118 may be received through the coupler 102, e.g., from the top 105, such that the coupler 102 retains the flange 122, while the base 120 extends downward therefrom.

The outer diameter of the base 120 may be sized to be received into the extension 104. In some embodiments, the base 120 may be snugly received into the extension 104, so as to limit lateral movement thereof. In other embodiments, however, the outer diameter of the base 120 may be smaller than the inner diameter of the extension 104, so as to facilitate the base 120 being received into the extension 104. Further, various tools (e.g., conical collars, etc.) may be employed to direct the base 120 of the bushing 118 into the extension 104.

The extension 104 may be a cylindrical structure of a diameter that is similar or slightly larger than that of the joint 26. In other embodiments, the extension 104 may be any other shape; however, a cylindrical geometry may facilitate the racking-back process by allowing the stand 14, with the extension assembly 100 attached thereto, to fit into the rack 10 in the same manner as stands, such as stand 12, that meet or exceed the minimum height requirement of the rack 10. Further, the extension 104 may be formed from any suitable material that may support the weight of the stand 14. However, in some instances, it may be advantageous for the extension 104 to be made of a relatively lightweight material, so as to allow the extension 104 to be manipulated manually into position without mechanical assistance. Accordingly, in various embodiments, the extension 104 may be made from aluminum, composites, or the like. In other embodiments, other factors, such as strength, cost, etc. may dictate that the material employed for the extension 104 be heavier, such as, for example, steel, iron, or the like.

In some embodiments, the bushing 118 may be slid into the extension 104 without further attachment to the extension 104 (e.g., without threading). This may facilitate handling of the stand 14 by allowing the coupler 102 and the short (relative to the extension 104) bushing 118 to be removed from the extension 104 and handled for deployment into the wellbore, as will be explained in greater detail below. In other embodiments, however, the extension 104 may be fixed to the bushing 118, or another element of the coupler 102, such that the extension 104 may move with the stand 14 as it is moved into position for deployment.

The bushing 118 may also be constructed from a relatively lightweight material, which may be lifted manually, for example. Further, the bushing 118 may not be required to support high loads, as the weight of the stand 14 may be taken up by the coupler 102 through the connection with the latch 112 and band 114 and transmitted to the extension 104. Further, lateral loads on the stand 14 may generally be taken up by the rack 10. However, the bushing 118 may be of sufficiently robust construction to survive repeated use, and avoid displacement or misalignment between the stand 14 and the extension 104 during use, but may not be designed to take high bending or compressive loads. In other embodiments, the bushing 118 may be load bearing, whether bending, compressive, or tensile, and may be constructed of high strength materials to support such load. In such embodiments, lifting machinery may be employed to position the bushing 118.

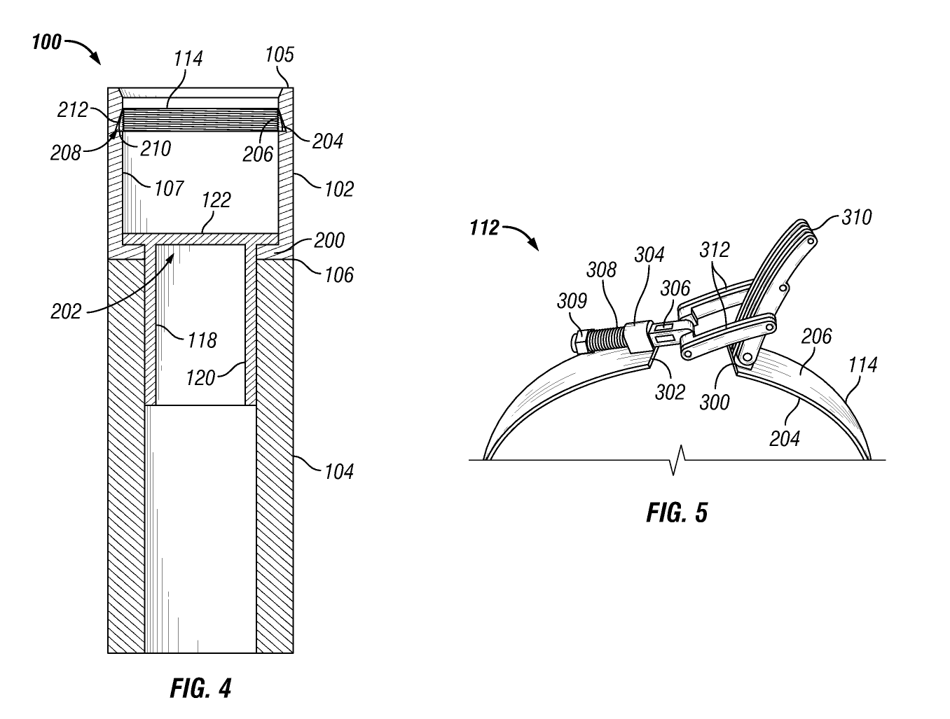

FIG. 4 illustrates a side cross-sectional view of the extension assembly 100, according to an embodiment. As described above, the extension assembly 100 includes the coupler 102, the extension 104, and the bushing 118. Further, the coupler 102 defines the inner diameter 107 extending between the top 105 and the bottom 106 thereof. As noted above, the flange 122 of the bushing 118 is retained within the coupler 102, for example, by a radially-extending wall 200 of the coupler 102. The radially-extending wall 200 may be disposed at the bottom 106 of the coupler 102 and may define an opening 202 therethrough. The opening 202 may be sized to allow the base 120 to pass therethrough, while preventing the flange 122 from passing.

Thus, the radially-extending wall 200 surrounding the opening 202 may catch and retain the bushing 118, keeping the bushing 118 from passing through the bottom 106, while allowing at least a portion of the base 120 to extend out of the coupler 102 and away from the top 105. Further, when the coupler 102 receives the pin end 108 of the joint 26 therein, the flange 122 may be entrained between the pin end 108 and the radially-extending wall 200. It will be appreciated that the radially-extending wall 200 need not be at the bottom 106 of the coupler 102, but may be positioned at an intermediate location, i.e., between the top 105 and bottom 106. In some embodiments, the radially-extending wall 200 may abut or otherwise engage the extension 104, at least when the bushing 118 is fully received through the coupler 102.

Turning now to the connection of the coupler 102 to the joint 26 (FIGS. 2 and 3), according to one specific embodiment, the band 114 may define a tapered outer surface 204 and a gripping inner surface 206. The gripping inner surface 206 may include teeth, e.g., in a sawtooth configuration, which may bite into or otherwise engage the joint 26 above the threaded area 110 thereof (see FIG. 2). In other embodiments, the radial contraction of the band 114 may cause an interference fit with the joint 26 or otherwise grip the joint 26 without marking the joint 26.

A groove 208 may be defined in the inner diameter 107 of the coupler 102. The groove 208 may, for example, include a shoulder 210 and a tapered surface 212. The tapered surface 212 may extend from the shoulder 210 toward the top 105 of the coupler. Further, the tapered surface 212 may be reverse angled with respect to the tapered outer surface 204 of the band 114. Accordingly, when engaged, pulling the coupler 102 away from the joint 26 (e.g., down, as shown) is converted into an inward gripping force by the tapered surfaces 204, 212 of the band 114 and the groove 208 sliding relative to one another. Thus, such force, rather than sliding the coupler 102 from engagement with the joint 26, results in a tighter engagement therebetween.

FIG. 5 illustrates an enlarged perspective view of the latch 112 and the band 114, according to an embodiment. As shown, the band 114 is a split ring, including circumferential ends 300, 302 that are coupled to either side of the latch 112. Closing the latch 112 draws the ends 300, 302 closer together, thereby decreasing the circumference of the band 114 such that the band 114 engages the joint 26 (e.g., FIG. 2).

The latch 112 may, in an embodiment, include a padeye 304 attached to the end 302 of the band 114. A draw bolt 306 passes through the padeye 304. An adjustable spring 308 may be coupled with the draw bolt 306 by a nut 309, so as to allow the tension in the band 114 to be varied according to desired gripping force, differences in the outer diameter of the joint 26, etc. Further, a handle 310 may be pivotably coupled to the other end 300 of the band 114 and may be pivotably coupled with the draw bolt 306 via links 312. Accordingly, when the handle 310 is pivoted toward the band (clockwise, as shown), the ends 300, 302 may be drawn together, such that the gripping surface 204 of the band 114 engages the joint 26 (FIGS. 2 and 3). This may be referred to as actuating the latch 112.

In an example of operation, the coupler 102 may serve as a thread protector, which may be employed on one, some, or all of the stands, regardless of whether they meet the minimum length requirements of the rack 10. If the stand is within acceptable length ranges, the coupler 102 may be employed without the bushing 118 or extension 104. In such case, the coupler 102 may be secured to the joint 26, e.g., with the threaded area 110 and the pin end 108 received therein and abutting the radially-extending wall 200. The stand 12 may then be racked back, with the coupler 102 being positioned between the pin end 108 and the platform (or ground, etc.), so as to protect the threaded area 110.

However, when racking back the short stand 14, the coupler 102 may receive the bushing 118 therethrough, e.g., prior to being secured to the joint 26. For example, the top 105 of the coupler 102 may be slid over the pin end 108 until the pin end 108 abuts or is proximal to the flange 122, e.g., at the bottom 106 of the coupler 102. The stand 14, with the coupler 102 and bushing 118 coupled thereto, may then be hoisted from the platform and moved to the rack 10.

The extension 104 may be positioned at or near an intended position for the stand 14 in the rack 10. The stand 14, with the coupler 102 and bushing 118 attached thereto, may then be lowered toward the extension 104. As the stand 14 is lowered, the base 120 of the bushing 118 may be received into the extension 104, until the radially-extending wall 200 or another region proximal the bottom 106 abuts or otherwise engages the extension 104. The length of the extension 104 may be sufficient to make up the shortfall of the stand 14, such that the stand 14 may be received and secured in the rack 10, similarly to the stand 12.

When the stand 14 is to be deployed, the process may, for example, be reversed. Thus, the stand 14 may be hoisted (e.g., by engagement with a spreader bar or an elevator) upwards, such that the bushing 118 is pulled out of the extension 104. The stand 14, with the coupler 102 providing thread protection therefor, may then be moved near to or above the platform hole. The coupler 102 may then be disengaged from the joint 26, e.g., by opening the latch 112 and relieving the gripping force applied by the band 114 to the joint 26. The coupler 102 and bushing 118 may then be slid off of the pin end 108, and the stand 14 may be made up to the box end of a tubular string already deployed into the wellbore.

Accordingly, it will be appreciated that embodiments of the extension assembly 100 may extend the length of a stand 14 that may otherwise be too short to be run as a standard triple. Further, the extension assembly 100 may employ a thread protector as the coupler 102 to couple the extension 104 with the joint 26, thereby facilitating continued thread protection, while allowing quick on and off of the thread protectors and efficient placement of the stand 14 in the rack 10. Furthermore, the bushing 118 that provides, in an embodiment, the attachment of the coupler 102 with the extension 104 may be protected from compressive and/or lateral loads by the rack 10 and the coupler 102, thereby allowing the bushing 118 to be made from relatively lightweight materials (e.g., in comparison to the joint 26 materials) that may facilitate handling of the coupler 102 and bushing 118 as they are attached and detached from the joint 26. Further, this avoidance of weight transmission via the bushing 118 may also avoid the end 108 of the joint 26 bearing the weight of the stand 14. For example, the weight of the stand 14 may be transmitted to the coupler 102 via engagement with the joint 26 above the threads, to the coupler 102, and to the extension 104 abutting the bottom of the coupler 102.

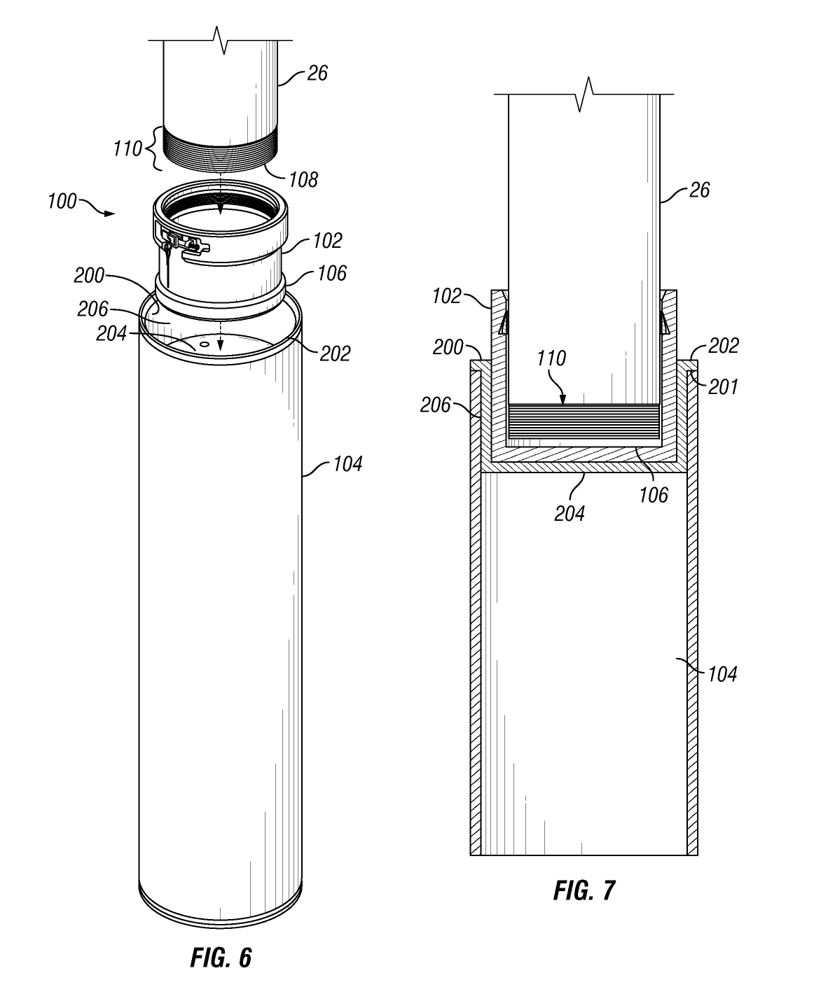

FIGS. 6 and 7 illustrate an exploded perspective view and a side cross-sectional view, respectively, of the joint 26 and another embodiment of the extension assembly 100. The extension assembly 100 may include the coupler 102, substantially as described above with reference to FIGS. 1-5, which may be received around the pin end 108 of the joint 26, so as to protect the threaded area 110. Further, the extension assembly 100 may include the extension 104, which may be provided to bear the weight of the stand 26 and extend its length.

The extension assembly 100 may also include an insert 200, which may be received into an open end 201 of the extension 104. The insert 200 may include a shoulder 202 that bears on the open end 201, a bottom plate 204 that spans the inner diameter of the extension assembly 100, and a sidewall 206 extending between the shoulder 202 and the bottom plate 204. The height of the insert 200 (e.g., from the top of the shoulder 201 to the bottom of the bottom plate 204) may be less than the height of the coupler 102, such that, as shown, a portion of the coupler 102 extends upwards from the insert 102. However, in other embodiments, the coupler 102 may be shorter than the insert 200, or the two may be about the same height.

The coupler 102 may be received into the insert 200 and may rest on the bottom plate 204 either before or after engaging the joint 26. Accordingly, the coupler 102 may transfer the weight of the joint 26 to the extension 104 via the bottom plate 204. Further, lateral movement of the coupler 102 may be restricted by the sidewall 206, as the sidewall 206 may be radially intermediate of the coupler 102 and the extension 104. Specifically, in some cases, the coupler 102 may be snugly received into the insert 200, such that the outer surface of the coupler 102 is substantially prevented from lateral movement with respect to the extension 104. In other cases, the insert 200 may omit the sidewall 206 and shoulder 201 and may, instead, be attached (e.g., welded) directly to the interior of the extension 104.

In the embodiment of FIGS. 6 and 7, the extension assembly 100 may extend the length of the joint 26 without requiring additional pieces to be attached to the stand 14 (FIG. 1) during handling operations, except when being racked back. For example, the stand 14 may be tripped out of the wellbore, and the coupler 102 positioned around the threaded area 110 of the join 26, similar to normal procedures for stands 12 that meet the minimum length requirements. During rack back, the coupler 102 and the joint 26 may be received into the extension 104, rather than being disposed on the ground. Further, the coupler 102 may both protect the threaded area 110 and transfer the weight of the stand 14 to the ground, via the extension 104, while avoiding requiring the pin end 108 from bearing the weight of the stand 14. It will be appreciated that at least one embodiment of the extension assembly 100 may include both a bushing 118 (e.g., FIG. 2) and an insert 200, without departing from the scope of the present disclosure.

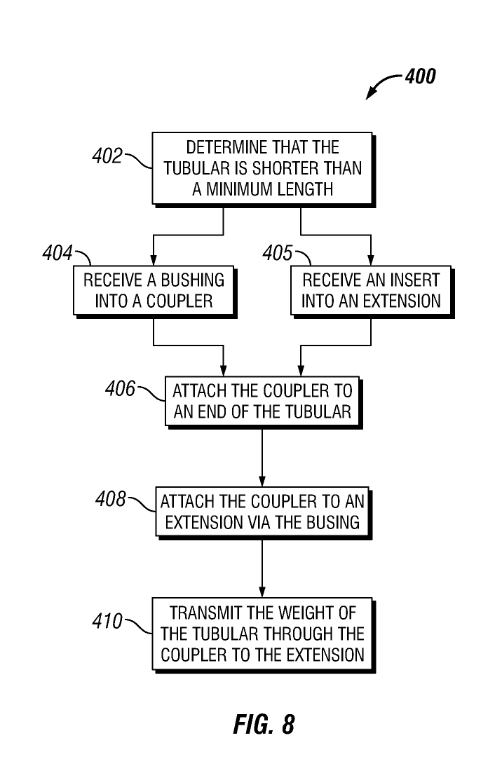

FIG. 8 illustrates a flowchart of a method 400 for extending a tubular, according to an embodiment. The method 400 may proceed by operation of an embodiment of the extension assembly 100, and is thus described herein with reference thereto. However, it will be appreciated that this is merely for illustrative purposes; the method 400 is not limited to any particular structure unless otherwise expressly stated herein.

The method 400 may begin by determining that a length of a stand 14 is below a minimum height for which the rack 10 is designed, as at 402. Such determination may be made, for example, prior to assembling the stand 14, i.e., by determining that any remaining joints add up to a length that is shorter than may be required for a stand (e.g., a three joint “triple”) by a particular rack 10. In another embodiment, the determination may occur after assembly of the stand 14.

In response to determining that the height of the stand 14 is below the minimum at 402, in one embodiment (e.g., for the extension assembly 100 of FIGS. 2-5), the method 400 may include receiving the bushing 118 in the coupler 102, as at 404. For example, the base 120 of the bushing 118 may be received through an opening 202 in the radially-extending wall 200 of the bushing 118. The flange 122 of the bushing 118 may have a diameter that is greater than the diameter of the opening 202 and may thus be prevented from sliding therethrough by the wall 200.

In another embodiment, (e.g., for the extension assembly 100 of FIGS. 6 and 7) method 400 may instead or additionally include receiving the insert 200 into the extension 104, as at 405. In some cases, the insert 200 may be received into the extension 104 prior to determining at 402. For example, the insert 200 may be fixed to the extension 104, e.g., via welding, in a generally permanent manner. As such, when the stand 14 is determined to be too short, at 402, the method 400 may include deploying the extension 102 with the insert 200 received and/or attached therein.

Before, during, or after, receiving the bushing 118 into the coupler 102 at 404 and/or receiving the insert 200 into the extension 104, the method 400 may include attaching the coupler 102 to the end 108 of the joint 26, as at 406. The coupler 102 may be a thread protector, which may be made from a suitably soft material that may serve to protect the threaded area 110 of the joint 26. For example, if the height exceeds the minimum, the coupler 102 may still be employed, but with the bushing 118 omitted.

In an embodiment, to attach the coupler 102 to the end 108 of the tubular at 406, the threaded area 110 of the joint 26 may be received into the coupler 102, such that the threaded area 110 is between the top 105 and the bottom 106 of the coupler 102. In some embodiments, the coupler 102 may be threaded to the joint 26 to provide the attachment. However, in other embodiments, the coupler 102 may include a quick-connect assembly, such as the band 114 and latch 112 described above. The band 114 and the latch 112 may be disposed proximal to the top 105 of the coupler 102. Accordingly, the band 114, upon actuation of the latch 112, may be configured to engage the joint 26 above the threaded area 110, so as to avoid engaging the threaded area 110. With the joint 26 received into the coupler 102, the flange 122 of the bushing 118 may be entrained between the wall 200 and the end 108 of the joint 26.

With the coupler 102 and the bushing 118 attached to the joint 26, the method 400 may proceed to attaching the coupler 102 to the extension 104, as at 408. For example, the extension 104 may be positioned at a predetermined location in the rack 10 where the stand 14 is to be placed. The stand 14, with the coupler 102 and the bushing 118 attached thereto, may be moved to the position, and lowered toward the extension 104. As the stand 14 is lowered, the base 120 of the bushing 118 may be received into the extension 104. When fully lowered, the extension 104 may bear on the bottom 106 of the coupler 102. In another embodiment (FIGS. 6 and 7), the coupler 102 may be lowered into the extension 104 until the coupler 102 rests on the bottom plate 204 of the insert 200, such that the bottom 106 of the coupler 102 bears on the bottom plate 204.

When the extension 104 or the bottom plate 204 bears against the bottom 106 of the coupler 102, for example, the method 400 may include transmitting the weight of the tubular stand 14 through the coupler 102 to the extension 104, as at 410. Accordingly, the weight of the stand 14, or at least a portion thereof, may be transmitted to the coupler 102 via the engagement between the band 114 and the joint 26. The weight may be transmitted from the coupler 102 to the abutting extension 104. Thus, the end 108 of the joint 26 may be protected from damage by bearing the weight of the stand 14.

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. An apparatus for extending a tubular, comprising:
a coupler comprising a top and a bottom, wherein the coupler is configured to receive an end of the tubular and attach to the tubular, wherein the coupler is at least partially constructed from a material that is softer than the tubular, such that the coupler is configured to protect a threaded area of the tubular when the tubular is received into the coupler;
a bushing received at least partially through the coupler and extending from the bottom of the coupler, away from the top; and
an extension receiving the bushing, such that, when the tubular is received into the coupler and the bushing is received into the extension, the extension extends substantially concentric to the tubular.

2. The apparatus of claim 1, wherein, when the tubular is received into the coupler, the threaded area thereof is received into the coupler and is disposed between the top and the bottom.

3. The apparatus of claim 1, wherein the coupler comprises a band and a latch coupled with band, wherein the band is configured to grip the tubular by actuation of the latch.

4. The apparatus of claim 3, wherein the band is positioned proximal the top of the coupler, such that the band is configured to engage the tubular above the threaded area, the threaded area being received into the coupler.

5. The apparatus of claim 1, wherein the bushing comprises a base and a flange, wherein at least the base is disposed within the coupler and engages a bottom of the coupler.

6. The apparatus of claim 5, wherein the coupler comprises a radially-extending wall defining an opening therein having a diameter that is greater than the outer diameter of the base and smaller than the outer diameter of the flange, wherein the base is received through the opening and the flange abuts the radially-extending wall, and wherein the extension abuts the radially-extending wall when the bushing is received into the extension.

7. The apparatus of claim 6, wherein, when the coupler receives the tubular, the flange is disposed between the end of the tubular and the radially-extending wall.

8. The apparatus of claim 6, wherein the base is slid into the extension without threading, the coupler bearing against the extension to transmit a weight of the tubular when the base is slid into the extension.

9. A method of racking a tubular, comprising:
attaching a coupler to the tubular, such that the coupler receives an end of the tubular, wherein the coupler comprises a material that is softer than a material of the end of the tubular, so as to protect a threaded area of the tubular;
attaching an extension to the coupler such that a height of the tubular plus a height of the extension meets a minimum height of a rack; and
positioning the tubular in the rack.

10. The method of claim 9, wherein attaching the coupler comprises decreasing a circumference of a band received around the tubular.

11. The method of claim 10, wherein attaching the coupler to the tubular comprises:
receiving the threaded area of the tubular into the coupler, such that the coupler surrounds the threaded area; and
engaging the tubular with the band above the threaded area.

12. The method of claim 9, wherein attaching the extension comprises:
receiving a bushing into the coupler such that at least a portion of a base of the bushing extends from the coupler; and
receiving the base at least partially into the extension.

13. The method of claim 12, wherein receiving the bushing into the coupler comprises receiving the base of the bushing through an opening defined in the coupler, wherein a flange of the bushing abuts a radially-extending wall of the coupler in which the opening is defined, and wherein the extension abuts the radially-extending wall when the extension is attached to the coupler.

14. The method of claim 12, wherein receiving the bushing into the extension comprises receiving the bushing into an inner diameter of the extension, wherein the extension has a cylindrical shape.

15. The method of claim 12, wherein attaching the coupler to the tubular comprises:
receiving a bushing into the tubular, such that a base of the tubular extends from the coupler;
receiving the end of the tubular into the coupler with the bushing received therein; and
gripping the tubular using the coupler with the bushing received therein.

16. The method of claim 9, further comprising:
receiving an insert into an open end of the extension; and
receiving the coupler into the open end of the extension, such that the coupler is supported by a bottom plate of the insert.

17. The method of claim 16, wherein receiving the insert further comprises disposing a shoulder of the insert against the open end, to support the insert in the extension.

18. The method of claim 9, wherein positioning the tubular in the rack comprises positioning the tubular on top of the extension, such that the extension bears at least a portion of a weight of the tubular.

19. The method of claim 9, further comprising determining that the tubular is shorter than the minimum height, wherein, attaching the extension to the coupler is in response to determining that the tubular is shorter than the minimum height.

20. An extension assembly, comprising:
a coupler configured to be positioned around a threaded area of a tubular, proximal to an end of the tubular;
an extension having an open end configured to receive at least a portion of the coupler, the extension being configured to be disposed at least partially between the end of the tubular and a support surface; and
an insert comprising a bottom plate disposed within the extension, wherein the coupler is configured to bear on the bottom plate, and wherein the bottom plate transfers a weight of the tubular from the coupler to the extension.

21. The extension assembly of claim 20, wherein the coupler comprises a band configured to attach the coupler to the tubular, away from the threaded area.

22. The extension assembly of claim 21, wherein the band is positioned proximal the top of the coupler, such that the band is configured to engage the tubular above the threaded area, the threaded area being received into the coupler.

23. The extension assembly of claim 20, wherein the insert further comprises a shoulder and a sidewall coupled with the bottom plate and the shoulder, wherein the shoulder bears on the open end of the extension.

24. The extension assembly of claim 23, wherein the sidewall is disposed radially intermediate of the coupler and the extension.
